(19) United States
(12) Patent Application Publication
(10) Pub. No.: US 2020/0009589 A1
(43) Pub. Date: Jan. 9, 2020

(54) ANTI-BACKFLOW EXTRUSION LIQUID CONTAINER

(71) Applicant: Shenzhen Global Egrow E-Commerce Co., LTD, Shenzhen (CN)

(72) Inventor: Lixia Liang, Guangdong (CN)

(73) Assignee: Shenzhen Global Egrow E-Commerce Co., LTD, Shenzhen (CN)

(21) Appl. No.: 16/367,281

(22) Filed: Mar. 28, 2019

(30) Foreign Application Priority Data
Jul. 5, 2018 (CN) 201821060464.1

(51) Int. Cl. B05B 11/04; B05B 12/08

(52) U.S. Cl. CPC B05B 11/047; B05B 12/087

(57) ABSTRACT

An anti-backflow extrusion liquid container includes an elastic container for storing and extruding liquid, a spraying tube inserted into the elastic container, a first one-way valve for controlling the opening and closing of the spraying tube, and a second one-way valve for adjusting the air pressure in the elastic container. The first one-way valve is disposed in the middle of the spraying tube, and the second one-way valve is disposed at the bottom of the elastic container. The disclosure not only prevents the liquid in the guide tube from flowing back into the bottle body during the restoring process of the bottle body and thus avoiding the liquid in the bottle body from being contaminated, but also enables the bottle body to be restored quickly after pressing and thus prolonging the service life of bottle and improving work efficiency.

### CROSS-REFERENCE TO RELATED APPLICATION

This application claims the priority benefit of China application serial No. 201821060464.1, filed on Jul. 5, 2018. The entirety of the above-mentioned patent application is hereby incorporated by reference herein and made a part of this specification.

### BACKGROUND OF THE DISCLOSURE

### Field of the Disclosure

The disclosure is related to the technical field of liquid containers, in particular to an anti-backflow extrusion liquid container.

### Description of Related Art

A dropper bottle is a type of container used in a chemical laboratory for containing a cleaning solution, which is equipped with a device for spraying liquid. Commonly used dropper bottles are classified into blown type and extruded type. The blown type bottle includes a glass flask with flat bottom, a blow tube and a water outlet tube provided at a mouth of the bottle. The extruded type bottle includes a plastic bottle with a narrow mouth and a water outlet tube provided at the mouth of the bottle. However, the existing extruded type cleaning bottle is generally made of plastic, and a bottle body will be cracked and scrapped after being used repeatedly for a period of time.

A Chinese patent document discloses a novel cleaning bottle (publication number: CN 207324868 U), including: a bottle body, an absorbing tube, a connecting member and an air bag. The bottle body is a sealed container with an open top, and a bottom portion of the connecting member is fixed to the open top of the bottle body. One end of the connecting member is provided with a nozzle, and the other end of the connecting member is connected to an air bag outside the bottle body. The absorbing tube is a tubular body, one end of which communicates with the nozzle, and the other end of which is projected into a bottom portion of the bottle body. The connecting member is provided with a channel communicating the bottle body with the air bag. Inside the connecting member is provided with a channel communicating a water outlet tube with the absorbing tube. To some extent, the above solution reduces the phenomenon of cracking of the bottle body caused by pressing, but such solution has at least the following defects: first, liquid in the nozzle flows back to the bottle body, causing the liquid in the bottle to be contaminated; second, it takes a relatively long time for the air bag to restore an original state after pressing, which reduces work efficiency.

### SUMMARY OF THE DISCLOSURE

The purpose of the disclosure is to provide an anti-backflow extrusion liquid container to compensate for the defect of known technology. The disclosure not only prevents the liquid in the guide tube from flowing back into the bottle body during the restoring process of the bottle body and thereby avoiding the liquid in the bottle body from being contaminated, but also enables the bottle body to be restored quickly after pressing and thereby prolonging the service life of bottle and improving work efficiency.

In order to achieve the above purpose, the disclosure adopts the following technical solutions:

An anti-backflow extrusion liquid container includes an elastic container for storing and extruding a liquid, a spraying tube inserted into the elastic container, a first one-way valve for controlling the opening and closing of the spraying tube, and a second one-way valve adjusting the air pressure in the elastic container. The first one-way valve is disposed at a middle portion of the spraying tube, and the second one-way valve is disposed at a bottom portion of the elastic container. The first one-way valve can prevent the liquid in the spraying tube from flowing back into the elastic container when the elastic container is restored to an original state. The second one-way valve enables the elastic container to be restored to the original state quickly according to the difference of the air pressure inside and outside the elastic container. When the air pressure inside and outside the elastic container are equal, the second one-way valve is in a closed state and thereby achieving the sealing effect.

As an improvement for the anti-backflow extrusion liquid container of the present disclosure, the first one-way valve includes a first valve and a first valve door disposed in the first valve. The first valve covers the first valve door through a first spring. The first valve includes a first valve body, a first connecting hole disposed at a top portion of the first valve body, and a first sealing structure for sealing a gap formed by the first valve body and the spraying tube. The first valve door includes a first base matching the first valve body, a first fixing rod integrally formed with the first base, and a second sealing structure for sealing a gap formed by the first base and a bottom of the first valve body. An end portion of the first fixing rod is connected to the first valve body through the first connecting hole. The first valve body covers the first valve door through the first spring, and the enhanced air pressure can push the first valve door to move upward, so that the first one-way valve is in an open state. When the air pressure is reduced, the first valve door is affected by the first spring and return to an original position, so the first one-way valve is in the closed state.

As an improvement for the anti-backflow extrusion liquid container of the present disclosure, the second one-way valve includes a second valve and a second valve door disposed in the second valve. The second valve covers the second valve door through a second spring. The second valve includes a second valve body, a second connecting hole disposed at a top portion of the second valve body, and a third sealing structure for sealing a gap formed by the second valve body and the elastic container. The second valve includes a second base matching the second valve body, a second fixing rod integrally formed with the second base, and a fourth sealing structure for sealing a gap formed by the second base and a bottom portion of the second valve body. An end portion of the second fixing rod is connected to the second valve body through the second connecting hole. The second valve body covers the second valve door through the second spring, and an external atmospheric pressure can push the second valve door to move upward, so that the second one-way valve is in the open state. When the air pressure inside and outside the elastic container are equal, the second valve door is affected by the second spring and returns to an original position, and the second one-way valve is in the closed state.

As an improvement for the anti-backflow extrusion liquid container of the present disclosure, the first valve body and the second valve body are both cylindrical structures. The first valve body and the second valve body may be designed as a cylindrical structure according to the shapes of the spraying tube and the elastic container, respectively.

As an improvement for the anti-backflow extrusion liquid container of the present disclosure, the first sealing structure, the second sealing structure, the third sealing structure and the fourth sealing structure are both sleeved with a sealing ring. The sealing ring has the advantages of being convenient for use, mature structure, low cost, and wear resistance, and so on.

As an improvement for the anti-backflow extrusion liquid container of the present disclosure, the elastic container includes a bottle body, an opening disposed at a top portion of the bottle body, and an isolating device disposed at a bottom portion of the bottle body for isolating the liquid from the second one-way valve. The isolating device covers the second one-way valve. The isolating device is disposed for preventing the liquid from affecting normal operation of the second one-way valve.

As an improvement for the anti-backflow extrusion liquid container of the present disclosure, the isolating device includes an isolating plug and a pad fixed to the isolating plug, and the isolating plug covers the second one-way valve. The isolating plug is a cylindrical structure, and the pad includes a ring base and a protrusion base disposed at a center of the ring base. The protrusion base is adopted to be fixed to the ring base as a pad to better secure the second one-way valve while enabling the second one-way valve to communicate with the external atmospheric pressure.

As an improvement for the anti-backflow extrusion liquid container of the present disclosure, an outer wall of the bottle body is provided with a plurality of annular protrusions. The outer wall of the bottle body is provided with an annular protrusion, which can increase friction force and achieve an anti-slippery effect.

As an improvement for the anti-backflow extrusion liquid container of the present disclosure, the spraying tube includes a guide tube and a connecting portion communicating with an end portion of the guide tube. The connecting portion passes through a sealing body and is assembled to the elastic container. The spraying tube is designed in a splitting manner to prevent the spraying tube from being scrapped due to damage of the guide tube, thereby reducing repairing cost.

As an improvement for the anti-backflow extrusion liquid container of the present disclosure, the guide tube and the connecting portion are both configured as cylindrical structures, and a diameter of the connecting portion is larger than a diameter of the guide tube. The diameter of the connecting portion is larger than the diameter of the tube to help eject smaller droplets.

The advantageous effect of the disclosure lies in that the disclosure includes the elastic container for storing and extruding liquid, the spraying tube inserted into the elastic container, the first one-way valve for controlling the opening and closing of the spraying tube, and the second one-way valve that adjusts the air pressure in the elastic container. The first one-way valve is disposed in the spraying tube, and the second one-way valve is disposed at the bottom portion of the elastic container. The first one-way valve can prevent the liquid in the spraying tube from flowing back into the elastic container when the elastic container is restored to the original state. The second one-way valve enables the elastic container to be restored to the original state quickly according to the difference of the air pressure inside and outside the elastic container. When the air pressure inside and outside the elastic container are equal, the second one-way valve is in the closed state and thereby achieving the sealing effect. The disclosure not only prevents the liquid in the guide tube from flowing back into the bottle body during the restoring process of the bottle body and thereby avoiding the liquid in the bottle body from being contaminated, but also enables the bottle body to be restored quickly after pressing and thus prolonging the service life of bottle and improving work efficiency.

### BRIEF DESCRIPTION OF THE DRAWINGS

FIG. 1 is a schematic view of the structure of the present disclosure.

FIG. 2 is a schematic exploded view of the present disclosure.

FIG. 3 is a schematic cross-sectional structural view of a first one-way valve of the present disclosure.

FIG. 4 is a schematic cross-sectional structural view of a second one-way valve of the present disclosure.

### DESCRIPTION OF EMBODIMENTS

Certain terms are used throughout the specification and the claims to refer to particular components. Those skilled in the art will appreciate that hardware manufacturers may refer to the same component by different terms. The present specification and the claims do not differentiate the components by the names, but the components are distinguished according to their functions. The word “comprising” as used throughout the specification and claims is in open term and should be interpreted as “including but not limited to”. “Substantially” means that in an acceptable error range, those skilled in the art can solve the technical problem within a certain error range and basically achieve the technical effect.

In the description of the present disclosure, it should be understood that the directions or positional relationships indicated by the terms “upper”, “lower”, “front”, “back”, “left”, “right”, and “horizontal”, etc. refer to the directions or positional relationships shown in the drawings, and are only for the convenience and simplicity of the description of the present disclosure but not intended to indicate or imply that the device or component referred to has a specific direction, is constructed and operated in a specific direction, and therefore should not be construed as a limitation to the disclosure.

In the present disclosure, unless otherwise explicitly stated and defined, the terms “disposed”, “connected”, “linked”, “fixed” and the like shall be interpreted in a broad sense, and may either refer to a fixed connection or a detachable connection, or integral connection; may be mechanical connection or electrical connection; may be direct connection, or may be indirect connection through an intermediate medium, or may be internal communication between the two components. For those skilled in the art, the specific meanings of the above terms in the present disclosure can be understood on a case-by-case basis.

The present disclosure will be further described in detail below with reference to the accompanying drawings, which should not be construed as a limitation of the disclosure.

### Embodiment 1

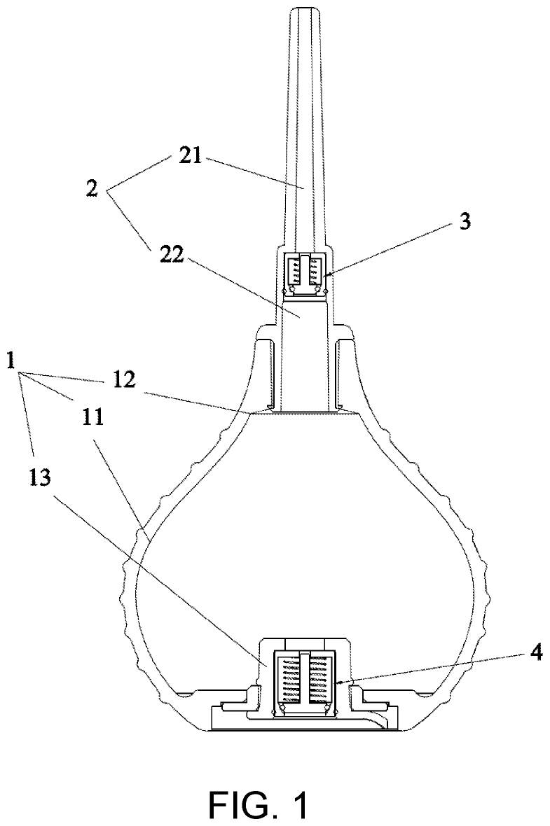

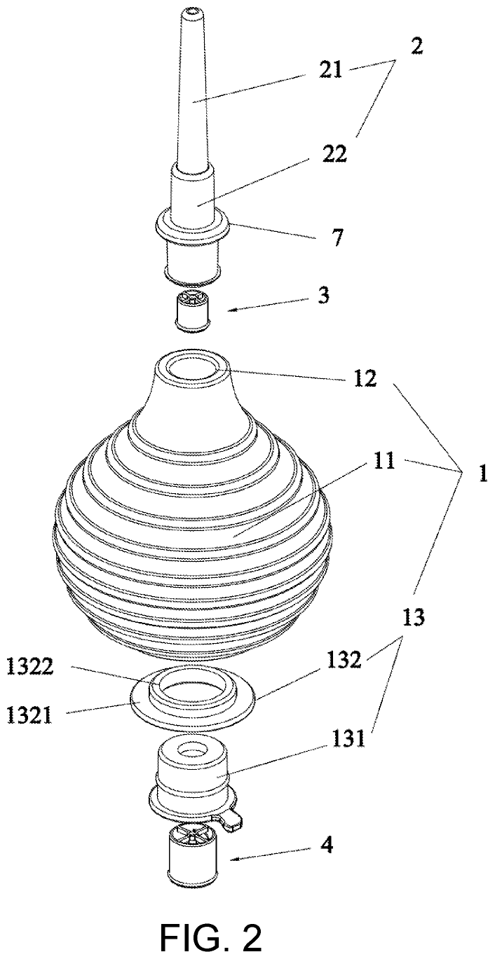

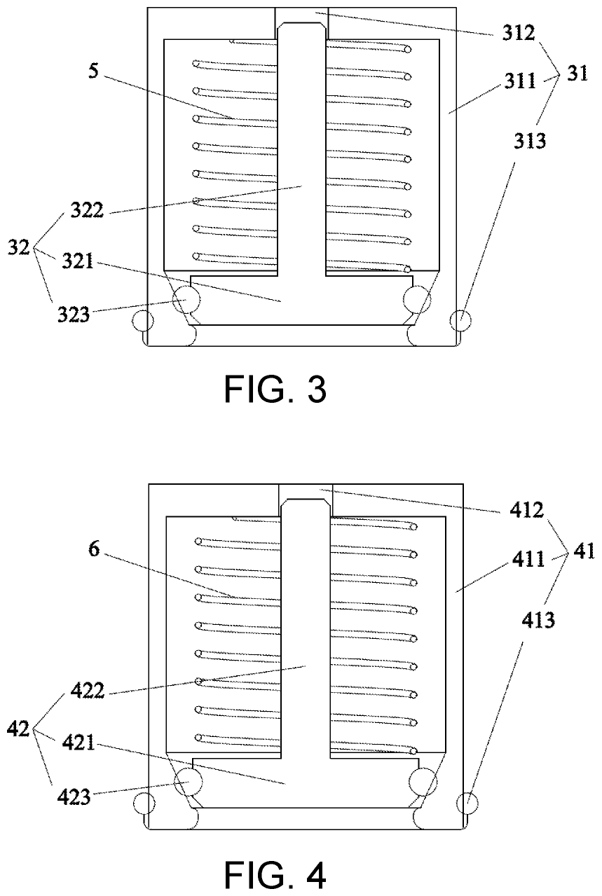

As shown in FIG. 1 to FIG. 4, an anti-backflow extrusion liquid container includes an elastic container 1 for storing and extruding liquid, a spraying tube 2 inserted into the elastic container 1, a first one-way valve 3 for controlling the opening and closing of the spraying tube 2, and a second one-way valve 4 for adjusting the air pressure in the elastic container 1. The first one-way valve 3 is disposed in a middle portion of the spraying tube 2, and the second one-way valve 4 is disposed at a bottom portion of the elastic container 1. The first one-way valve 3 can prevent the liquid in the spraying tube 2 from flowing back into the elastic container 1 when the elastic container 1 is restored to an original state. The second one-way valve 4 enables the elastic container 1 to be restored to the original state quickly according to the difference between the air pressure inside and outside the elastic container 1. When the air pressure inside and outside the elastic container 1 are equal, the second one-way valve 4 is in a closed state, and thereby achieving a sealing function.

Preferably, the first one-way valve 3 includes a first valve 31 and a first valve door 32 disposed in the first valve 31. The first valve 31 covers the first valve door 32 through a first spring 5. The first valve 31 includes a first valve body 311, a first connecting hole 312 disposed at a top portion of the first valve body 311, and a first sealing structure 313 for sealing a gap formed by the first valve body 311 and the spraying tube 2. The first valve door 32 includes a first base 321 matching the first valve body 311, a first fixing rod 322 integrally formed with the first base 321, and a second sealing structure 323 for sealing a gap formed by the first base 321 and the first valve body 311. An end portion of the first fixing rod 322 is connected to the first valve body 311 through the first connecting hole 312. The first valve 31 covers the first valve door 32 through the first spring 5, and the enhanced air pressure can push the first valve door 32 to move upward, so that the first one-way valve 3 is in an open state. When the air pressure is reduced, the first valve door 32 is affected by the first spring 5 and is restored to an original position, and the first one-way valve 3 is in the closed state.

Preferably, the second one-way valve 4 includes a second valve 41 and a second valve door 42 disposed in the second valve 41. The second valve 41 covers the second valve door 42 through a second spring 6. The second valve 41 includes a second valve body 411, a second connecting hole 412 disposed at a top portion of the second valve body 411, and a third sealing structure 413 for sealing the gap formed by the second valve body 411 and the elastic container 1. The second valve door 42 includes a second base 421 matching the second valve body 411, a second fixing rod 422 integrally formed with the second base 421, and a fourth sealing structure 423 for sealing a gap formed by the second base 421 and a bottom portion of the second valve body 411. An end portion of the second fixing rod 422 is connected to the second valve body 411 through the second connecting hole 412. The second valve 41 covers the second valve door 42 through the second spring 6. The external atmospheric pressure can push the second valve door 42 to move upward, so that the second one-way valve 4 is in the open state. When the air pressure inside and outside the elastic container 1 are equal, the second valve door 42 is returned to an original position by the action of the second spring 6, and the second one-way valve 4 is in the closed state.

Preferably, the first valve body 311 and the second valve body 411 are both cylindrical structures, and the first sealing structure 313, the second sealing structure 323, the third sealing structure 413 and the fourth sealing structure 423 are each sleeved with a sealing ring. The first valve body 311 and the second valve body 411 can be adjusted to a cylindrical structure according to the shapes of the spraying tube 2 and the elastic container 1, respectively. Meanwhile, the sealing ring has the advantages of being convenient for use, mature structure, low cost, and wear resistance, and so on.

The elastic container 1 of the present disclosure includes a bottle body 11, an opening 12 disposed at a top portion of the bottle body 11, and an isolating device 13 disposed at a bottom portion of the bottle body 11 for isolating the liquid from the second one-way valve 4. The isolating device 13 covers the second one-way valve 4. An outer wall of the bottle body 11 is provided with a plurality of annular protrusions. The isolating device 13 is disposed for preventing the liquid from affecting the normal operation of the second one-way valve 4. The outer wall of the bottle body 11 is provided with an annular protrusion, which can increase the friction force and achieve an anti-slippery function.

Preferably, the spraying tube 2 includes a guide tube 21 and a connecting portion 22 that communicating with the end portion of the guide tube 21. The connecting portion 22 is fixed to the elastic container 1 through the sealing body 7. The spraying tube 2 is designed in a splitting manner to prevent the spraying tube 2 from being scrapped due to damage of the guide tube 21, thereby reducing repairing cost.

The operation principle of the disclosure is:

Storing liquid: When the bottle body 11 stores the liquid, the first one-way valve 3 and the second one-way valve 4 are both in the closed state, so that the liquid in the bottle body 11 cannot be leaked, thereby achieving the effect of sealing the bottle body 11.

Spraying liquid: When the liquid needs to be sprayed, the elastic container 1 is squeezed, and the first one-way valve 3 is subjected to the upward air pressure and the enhanced liquid pressure, and the first valve door 32 moves upward. The liquid is sprayed from the guide tube 21, and the second one-way valve 4 is still in the closed state through the effect of the downward air pressure and the enhanced liquid pressure. When the liquid is not required to be sprayed, the elastic container 1 is released, the air pressure in the elastic container 1 is lowered, and the first one-way valve 3 is not affected by the upward air pressure. Moreover, since the liquid pressure in the upper-half portion of the guide tube is enhanced, the first valve door 32 is returned to the original position by the action of the first spring 5, and the first one-way valve 3 is in the closed state, thereby cutting the liquid in the guide tube 21 from flowing back. The second one-way valve 4 is subjected to the action of the external atmospheric pressure, the second valve door 42 moves upward, the air enters the elastic container 1, and the elastic container 1 begins to restore to the original state. When the air pressure inside and outside the elastic container 1 are equal, the second one-way valve 4 is not affected by the external atmospheric pressure, and the second valve door 42 returns to the original position by the action of the second spring 6, the second one-way valve 4 is in the closed state, and the elastic container 1 is completely restored to the original state.

### Embodiment 2

Different from the Embodiment 1, the isolating device 13 of the present embodiment includes an isolation plug 131 and a pad 132 fixed to the isolating plug 131. The isolating plug 131 covers the second one-way valve 4, and the isolating plug 131 is a cylindrical structure. The pad 132 includes a ring base 1321 and a protrusion base 1322 disposed at a center of the ring base 1321. The protrusion base 1322 is adopted to be fixed to the ring base 1321 as the pad 132 to better secure the second one-way valve 4 while enabling the second one-way valve 4 to be in communication with the external atmospheric pressure.

Other structures are the same as those in Embodiment 1, and thus are not described herein again.

### Embodiment 3

Different from the Embodiment 1, the guide tube 21 and the connecting portion 22 are both designed as a cylindrical structure, and a diameter of the connecting portion 22 is larger than a diameter of the guide tube 21. The diameter of the connecting portion 22 is larger than the diameter of the guide tube 21 to help eject smaller droplets.

Other structures are the same as those in Embodiment 1, and are not described herein again.

Variations and modifications can also be made to the above-described embodiments by those skilled in the art in light of the above disclosure. Therefore, the present disclosure is not limited to the specific embodiments described above, and any obvious improvements, substitutions or variations made by those skilled in the art on the basis of the present disclosure are within the scope of the present disclosure. In addition, although some specific terms are used in the specification, these terms are for convenience of description and do not constitute any limitation to the present disclosure.

What is claimed is:

1. An anti-backflow extrusion liquid container, comprising an elastic container for storing and extruding liquid, a spraying tube inserted in the elastic container, a first one-way valve for controlling opening and closing of the spraying tube, and a second one-way valve for adjusting air pressure in the elastic container, the first one-way valve being disposed at a middle portion of the spraying tube, the second one-way valve being disposed at a bottom portion of the elastic container.

2. The anti-backflow extrusion liquid container according to claim 1, wherein the first one-way valve comprises a first valve and a first valve door disposed in the first valve, the first valve covers the first valve door through a first spring, the first valve comprises a first valve body, a first connecting hole disposed at a top portion of the first valve body, and a first sealing structure for sealing a gap formed by the first valve body and the spraying tube, the first valve door comprises a first base matching the first valve body, a first fixing rod integrally formed with the first base, and a second sealing structure for sealing a gap formed by the first base and a bottom portion of the first valve body, an end portion of the first fixing rod is connected to the first valve body through the first connecting hole.

3. The anti-backflow extrusion liquid container according to claim 2, wherein the second one-way valve comprises a second valve and a second valve door disposed in the second valve, the second valve covers the second valve door through a second spring, the second valve comprises a second valve body, a second connecting hole disposed at a top portion of the second valve body, and a third sealing structure for sealing a gap formed by the second valve body and the elastic container, the second valve door comprises a second base matching the second valve body, a second fixing rod integrally formed with the second base, and a fourth sealing structure for sealing a gap formed by the second base and a bottom portion of the second valve body, and an end portion of the second fixing rod is connected to the second valve body through the second connecting hole.

4. The anti-backflow extrusion liquid container according to claim 3, wherein the first valve body and the second valve body are both cylindrical structures.

5. The anti-backflow extrusion liquid container according to claim 3, wherein the first sealing structure, the second sealing structure, the third sealing structure and the fourth sealing structure are sleeved with a sealing ring.

6. The anti-backflow extrusion liquid container according to claim 1, wherein the elastic container comprises a bottle body, an opening disposed at a top portion of the bottle body, and an isolating device disposed at a bottom portion of the bottle body for isolating liquid from the second one-way valve, the isolating device covers the second one-way valve.

7. The anti-backflow extrusion liquid container according to claim 6, wherein the isolating device comprises an isolating plug and a pad fixed to the isolating plug, the isolation plug covers the second one-way valve, the isolating plug is a cylindrical structure, and the pad comprises a ring base and a protrusion base disposed in a center of the ring base.

8. The anti-backflow extrusion liquid container according to claim 6, wherein an outer wall of the bottle body is provided with a plurality of annular projections.

9. The anti-backflow extrusion liquid container according to claim 1, wherein the spraying tube comprises a guide tube and a connecting portion communicating with an end portion of the guide tube, the connecting portion is assembled to the elastic container by passing through a sealing body.

10. The anti-backflow extrusion liquid container according to claim 9, wherein the guide tube and the connecting portion are both configured as cylindrical structures, a diameter of the connecting portion is larger than a diameter of the guide tube.
